(19) United States
(12) Patent Application Publication
(10) Pub. No.: US 2024/0113325 A1
(43) Pub. Date: Apr. 4, 2024

(54) SOLID-STATE ELECTROLYTES FOR ALUMINUM METAL BATTERIES AND METHODS OF MAKING THE SAME

(71) Applicant: Revolution Power Inc., Seattle, WA (US)

(72) Inventors: David Shock, Bainbridge Island, WA (US); Yujia Liang, Bellevue, WA (US); Daniel Wainwright Shaw, Seattle, WA (US); James Bradley Downar, III, Seattle, WA (US)

(21) Appl. No.: 18/376,350

(22) Filed: Oct. 3, 2023

Related U.S. Application Data
(60) Provisional application No. 63/412,984, filed on Oct. 4, 2022.

(51) Int. Cl. H01M 10/056; H01M 4/04; H01M 4/134; H01M 4/1395; H01M 4/38; H01M 4/62; H01M 10/0585; H01M 50/105

(52) U.S. Cl. CPC H01M 10/056; H01M 4/0404; H01M 4/134; H01M 4/1395; H01M 4/38; H01M 4/625; H01M 10/0585; H01M 50/105; H01M 2004/028; H01M 2300/0065; H01M 2300/0091; H01M 2300/0094

(57) ABSTRACT

Methods and systems are provided for manufacturing and implementing solid-state electrolytes (SSEs) for aluminum-based rechargeable batteries and other secondary batteries. In some examples, a SSE composition may include a mixture including urea, sodium chloride, sodium borate, magnesium sulfate, and sodium silicate. In certain examples, the SSE composition may further include carboxymethyl cellulose. In some examples, an aluminum-based secondary battery may be formed by applying a first portion of the SSE composition to an aluminum-based anode via slot-die coating and a second portion of the SSE composition to a cellulose membrane to form a SSE layer, and combining the coated aluminum-based anode, the SSE layer, and a sulfur-based cathode. In certain examples, a current pulse may be applied to the aluminum-based secondary battery to activate in situ solid-electrolyte interphase layers.

### CROSS-REFERENCE TO RELATED APPLICATION

The present application claims priority to U.S. Provisional Application No. 63/412,984, entitled “SOLID-STATE ELECTROLYTES FOR ALUMINUM METAL BATTERIES AND METHODS OF MAKING THE SAME” and filed on Oct. 4, 2022. The entire contents of the above-identified application are hereby incorporated by reference for all purposes.

### FIELD

Embodiments of the subject matter disclosed herein relate to electrolytes for secondary batteries, such as secondary batteries including an aluminum metal electrode, and more particularly to solid-state electrolytes for use in secondary batteries and methods for making the solid-state electrolytes.

### BACKGROUND

The current recharge, or secondary, battery market is dominated by lithium-ion batteries (LIBs). LIBs have been developed for several decades to achieve acceptable energy densities, cycle life, and rate performance, e.g., to achieve decarbonization. However, the current raw materials used to manufacture LIBs are nonuniformly distributed on a global scale. Considering deleterious impacts to the supply chain (e.g., such as caused by the COVID-19 pandemic), alternative options to lithium may be favored, especially for sociopolitical entities who have more abundant and evenly distributed raw materials than lithium. Dendric growth is also a big concern in LIBs, which can affect performance by puncturing cells. Usage of highly reactive lithium, rare-earth metals, and certain organic solvents may introduce environmental issues in end-of-life LIB disposal. As such, an environmentally benign energy storage approach which maintains cell performance and cell construction is in demand. In addition, current LIBs still cannot meet energy density demands for space- and weight-limited applications. Therefore, non-lithium chemistries may be desirable in energy storage.

Up to now, one focus of developing non-lithium chemistries is on alkali-ion batteries such as sodium-ion batteries (SIB s) and potassium-ion batteries (PIBs). As Li, Na, and K all belong to Group IA of the Periodic Table, their similarity stimulates development of SIBs and PIBs based on LIBs. Unfortunately, sodium metal and potassium metal are more reactive than lithium metal. Thus, stability and performance concerns of SIBs and PIBs may be exaggerated compared to LIBs. Moreover, the electrochemistry and battery architecture of SIBs and PIBs are directly transferred from LIBs, and the origins of performance concerns, environmental hazards, and low energy densities remain unresolved. Other emerging technologies include multivalent-ion batteries, like calcium, magnesium, and zinc ion batteries. However, research is still in early stages and restricted by a lack of high-performance electrodes or electrolytes.

### BRIEF DESCRIPTION OF THE DRAWINGS

FIG. 1 shows an example process for making a solid-state electrolyte (SSE) by wet powder mixing, in accordance with at least one embodiment;

FIG. 2 shows an example depth profile of O element in aluminum foil, in accordance with at least one embodiment;

FIG. 3 shows an example depth profile of Al element in aluminum foil, in accordance with at least one embodiment;

FIG. 4 shows an example X-ray diffraction (XRD) pattern of synthesized graphite, in accordance with at least one embodiment;

FIG. 5 shows an example Raman spectrum of synthesized graphite, in accordance with at least one embodiment;

FIG. 6 shows an example process for making a SSE by dry powder mixing, in accordance with at least one embodiment;

FIG. 7 shows an electrochemical impedance spectrum (EIS) of example cells made from powder processing, in accordance with at least one embodiment;

FIG. 8 shows charge/discharge curves of example cells made from powder processing, in accordance with at least one embodiment;

FIG. 9 shows an EIS of example cells made from powder processing with acetone, in accordance with at least one embodiment;

FIG. 10 shows charge/discharge curves of example cells made from powder processing with acetone, in accordance with at least one embodiment;

FIG. 11 shows an example slot-die process, in accordance with at least one embodiment;

FIG. 12 shows example viscosities of different solutions, in accordance with at least one embodiment;

FIG. 13 shows an example viscosities of different carboxymethyl cellulose (CMC) solutions, in accordance with at least one embodiment;

FIG. 14 shows an example plot of film thickness vs. coating speed, in accordance with at least one embodiment;

FIG. 15 shows an example process for making cells using a slot-die coated SSE, in accordance with at least one embodiment;

FIGS. 16 and 17 respectively show electrochemical impedance spectra (EISs) of an example as-built cell including a slot-die coated SSE before and after being charged for 1 hour, in accordance with at least one embodiment;

FIG. 18 shows charge/discharge curves of an example as-built cell including a slot-die coated SSE after being charged for 1 hour, in accordance with at least one embodiment;

FIG. 19 shows voltage and current during and after applying constant voltage to an example as-built cell, in accordance with at least one embodiment;

FIG. 20 shows charge/discharge curves of an example as-built cell including a slot-die coated SSE under application of a constant voltage, in accordance with at least one embodiment;

FIG. 21 shows voltage and current before, during, and after applying an electrical pulse to an example as-built cell including a slot-die coated SSE, in accordance with at least one embodiment;

FIG. 22 shows an EIS of an example as-built cell including a slot-die coated SSE after pulse and cycling, in accordance with at least one embodiment;

FIG. 23 shows charge/discharge curves of an example as-built cell including a slot-die coated SSE after pulse, in accordance with at least one embodiment; and

FIG. 24 shows a schematic cross-sectional diagram of an example as-built cell, in accordance with at least one embodiment.

### DETAILED DESCRIPTION

Techniques described and suggested herein include at least one embodiment of a solid-state electrolyte composition, including: a mixture comprising urea, sodium chloride, sodium tetraborate, magnesium sulfate, and sodium silicate, wherein: a total amount of the urea and the sodium chloride may account for 50 wt % to 95 wt % of the mixture; a total amount of the sodium tetraborate may account for 0.1 wt % to 25 wt % of the mixture; a total amount of the magnesium sulfate may account for 0.1 wt % to 25 wt % of the mixture; a total amount of the sodium silicate may account for 0.1 wt % to 10 wt % of the mixture; and an atomic ratio of sodium chloride to urea may be equal to or greater than 1.

In at least one embodiment, a method for forming an aluminum-based secondary battery may include: forming a cathode by: applying a sulfur-based mixture to coat a current collector; pressing the coated current collector; and drying the pressed and coated current collector to form a sulfur-based cathode active material layer thereon; forming an anode by mechanically and chemically treating an aluminum foil; forming a suspension by combining urea, sodium chloride, sodium tetraborate, magnesium sulfate, and sodium silicate; forming a coated anode by: slot-die coating a first portion of the suspension onto the anode; and drying the slot-die coated anode; forming a solid-state electrolyte by: applying a second portion of the suspension to coat a cellulose membrane; and drying the coated cellulose membrane; combining and pressing the cathode, the coated anode, and the solid-state electrolyte; drying the pressed and combined cathode, coated anode, and solid-state electrolyte to form a cell stack; and sealing the cell stack in a pouch.

In at least one embodiment, an aluminum-based secondary battery system may include: a cell stack, including: an anode including aluminum foil; a cathode including a current collector having a sulfur-based cathode active material coated thereon; a solid-state electrolyte layer interposed between the anode and the cathode, the solid-state electrolyte layer including a cellulose membrane saturated with a solid-state electrolyte including a mixture of urea, sodium chloride, sodium borate, magnesium sulfate, and sodium silicate; and in situ solid-electrolyte interphase layers interposed between the cathode and the solid-state electrolyte layer and between the anode and the solid-state electrolyte layer; and a pouch enclosing the cell stack, wherein the aluminum-based secondary battery system may be configured to apply a current pulse to the cell stack.

These, as well as other aspects, advantages, and alternatives will become apparent to those of ordinary skill in the art by reading the following detailed description, with reference where appropriate to the accompanying drawings. Further, it should be understood that descriptions and figures provided herein are intended to illustrate the invention by way of example only and, as such, that numerous variations are possible.

For example, the following description relates to various embodiments of a solid-state electrolyte (SSE) for aluminum secondary batteries, which in some embodiments may eliminate usage of corrosive and/or expensive ionic liquid(s) which may be applied in (manufacture of) liquid aluminum-ion batteries. The SSE, in some examples, may include a mixture of salts including urea, sodium chloride, sodium borate (e.g., sodium tetraborate), magnesium sulfate, and/or sodium silicate. In additional or alternative examples, the mixture of salts may include potassium chloride. To address the difficulty of making dense disc-size SSE wafers for some examples, a slot-die process is described herein to make the SSE by slurry coating. In certain embodiments, the slot-die process may easily be scaled up to industrial mass production. In exemplary embodiments, a pulse of current may be applied to an as-assembled cell to create in situ solid electrolyte interphase layers to inhibit electrolyte decomposition and prevent cathode-reactive materials diffusing into the SSE.

Compared to alkali-metal-ion (Li⁺, Na⁺, and K⁺) batteries, various embodiments discussed herein may eliminate usage of flammable and/or toxic liquid electrolytes. Compared to multi-valent-ion batteries (Mg²⁺, Ca²⁺, and Al³⁺), various embodiments discussed herein adopt an SSE to avoid corrosive and/or moisture-sensitive ionic liquids. Contrary to some SSE-making processes, some embodiments include a slurry coating process by a slot-die coating method. To solve instability between the electrode and the electrolyte of some examples, various embodiments utilize a unique charging protocol to create a robust SEI by applying an electrical pulse.

Various embodiments include a SSE to replace ionic liquids as electrolytes for aluminum secondary batteries, such as aluminum-ion batteries (AIBs). For certain embodiments, raw materials of the SSE may be easily accessible at a low cost. The SSE in various examples may be compatible with commonly used battery parts including packaging materials, current collectors, and/or tabs.

Various embodiments can include one or more of the following innovations: SSE composition; a scalable process to make the SSE; or a charging protocol to create an in-situ SEI to stabilize the electrode/electrolyte interface.

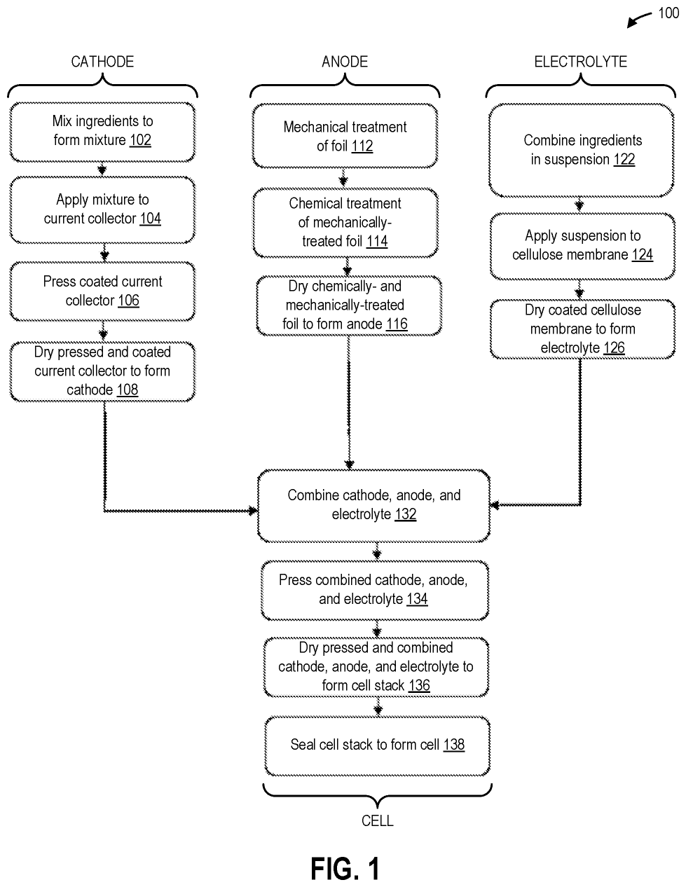

Various embodiments include a composition that may be used as a basis for an aluminum-based SSE. In an exemplary embodiment, the composition may include a mixture including urea, magnesium sulfate (MgSO₄), sodium chloride (NaCl), sodium tetraborate, sodium silicate, carboxymethyl cellulose (CMC), and/or water. Various embodiments may include a scalable method to make SSEs by slot-die coating. This coating method of various examples may be easily applied in industrial manufacturing. Various embodiments may include a cell-activating method by applying a high voltage or a large current to establish conduction pathways and forming a robust SEI. The cell-activating method may be applied in some examples to cells that have high impedance including but not limited to Al-based, Mg-based, and/or Ca-based solid-state cells. Accordingly, though methods and systems described herein are exemplified with Al-based solid-state cells, such methods and systems may be analogously applied to Mg-based and/or Ca-based solid state cells. For instance, for Mg-based and/or Ca-based solid state cells, the processes described in detail with reference to FIGS. 1, 6, 11, and 15 may be performed in an atmosphere-controlled environment to prevent or otherwise limit reaction(s) between Mg and/or Ca metals and air.

### The Composition of the SSE of Some Embodiments

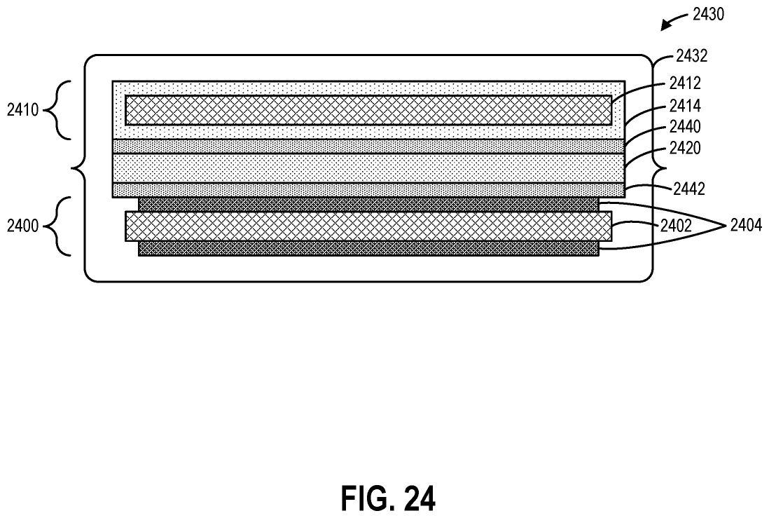

An example as-built cell 2430 is shown in FIG. 24, including a pouch 2432 enclosing an SSE 2420 interposed between an anode 2410 including a metal foil 2412 (e.g., Al foil) optionally coated with a SSE slurry-based layer 2414 and a cathode 2400 including a current collector 2402 coated with a cathode active material layer 2404. In certain embodiments, in situ SEI layers 2440 and 2442 may additionally be interposed between the anode 2410 and the SSE 2420 and the cathode 2400 and the SSE 2420. An example of a process 100 of making such a SSE, e.g., for Al-metal batteries, is depicted in FIG. 1. In some embodiments, the process 100 may include making an anode, a cathode, and an SSE, the SSE being formed via wet powder mixing, and forming a cell including the anode, the cathode, and the SSE.

In at least one embodiment, the process 100 may include forming the anode (e.g., the anode 2410) by mechanically treating 112 a metal foil (e.g., the metal foil 2412), chemically treating 114 the mechanically-treated foil, and drying 116 the chemically- and mechanically-treated foil.

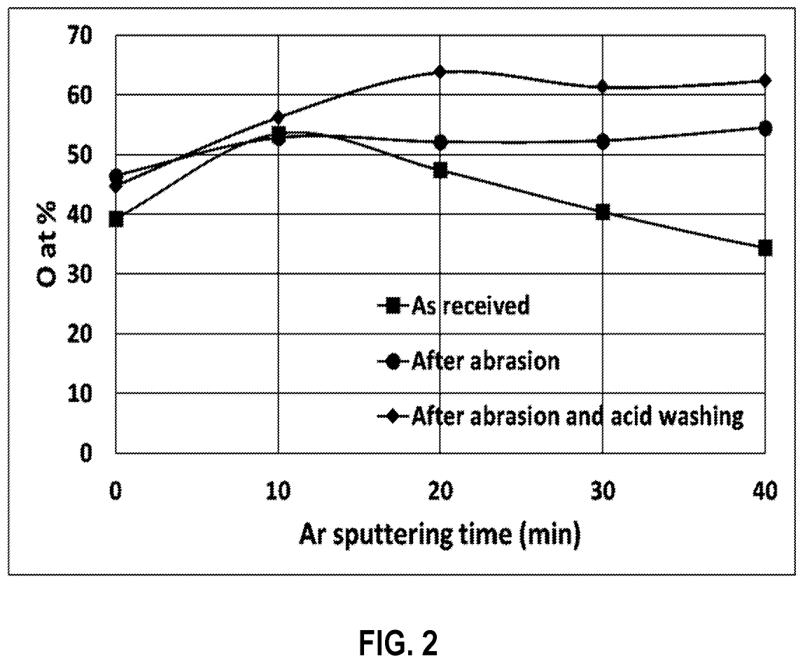

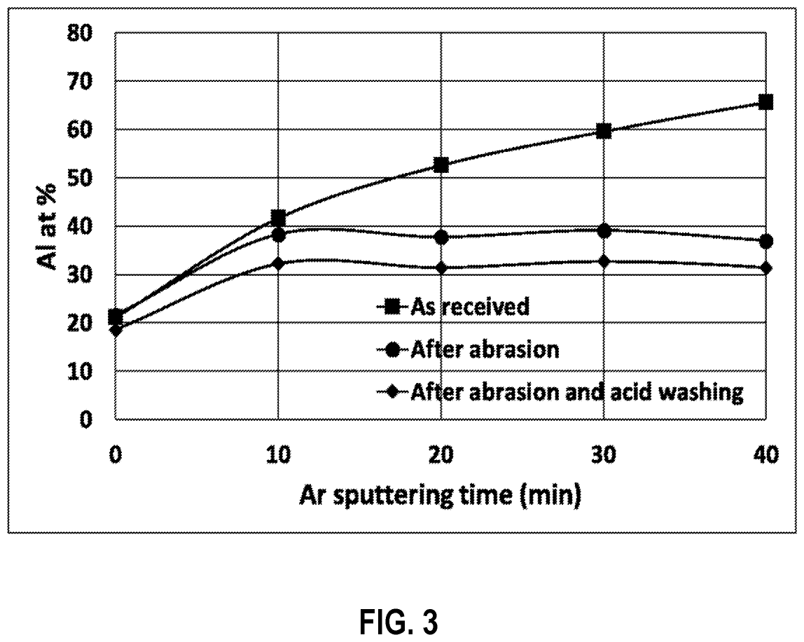

The metal foil, which in certain embodiments may be an aluminum (Al) foil, may have a thick surface oxide layer which may inhibit charge transfer of ions, incur overpotential, and reduce energy density. As shown in FIGS. 2 and 3, based on an X-ray photoelectron spectroscopic (XPS) estimation, a surface oxide layer of the (as-received) aluminum foil can be 4-5 nm thick in various examples. Two other samples plotted in FIGS. 2 and 3 are Al foil being abraded (e.g., metal foil after undergoing a mechanical treatment) and Al foil being abraded followed by an acid, such as HCl, modifying the surface (e.g., metal foil after undergoing mechanical and chemical treatments). Compared to the abraded aluminum foil, the as-received Al foil displayed less O signal but a higher Al signal towards the depth. Based on FIG. 2, the surface oxide layer may well protect an inner surface of Al foil from being oxidized. In a control experiment, after abrasing the Al foil, 6 mol/L HCl may be added onto the surface of the Al foil. The addition of acid in this example does not significantly modify the O and Al distributions compared to the abraded foil, except for detection of a Cl signal. Although the O concentration may continue to increase during sputtering in both abraded and HCl-treated aluminum foil, this may be attributed in some examples to surface roughness caused by the abrasion process and the HCl washing process. The rough surfaces of the abraded sample and HCl-treated sample may lead to a better connection between the anode and the SSE in various embodiments. In certain embodiments, one product of HCl-treated foil may include AlCl₃ which may facilitate charge transfer due to its better conductivity than Al₂O₃. Therefore, in various examples, the Al foil may be well protected by its surface oxide layer. The abrasion treatment may increase the surface roughness to enhance an interaction between the Al foil and the SSE in some embodiments. After the abrasion treatment, HCl addition can deliver an AlCl₃ layer which can improve the ion diffusion. Although AlCl₃ can be desirable in some embodiments, in additional or alternative embodiments Al₂(SO₄)₃, Al(NO₃)₃, AlBr₃, AlF₃, and other aluminum salts may be included in a surface coating layer. In some embodiments, the abrasion may not be necessary for coating such layers.

In at least one embodiment, the process 100 may include forming the cathode (e.g., the cathode 2400) by mixing 102 one or more first ingredients (e.g., graphite, sulfur, polyvinyl acetate, and/or urethane) to form a mixture, applying 104 the mixture to a current collector (e.g., the current collector 2402), pressing 106 the coated current collector, and drying 108 the pressed and coated current collector (e.g., thereby forming a cathode active material layer, such as the cathode active material layer 2404, on the current collector via the applying 104, the pressing 106, and the drying 108).

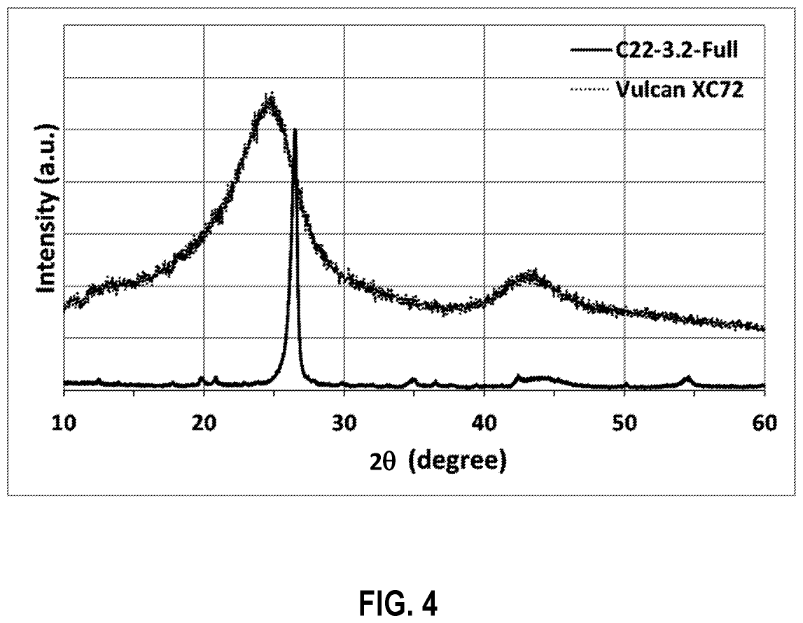

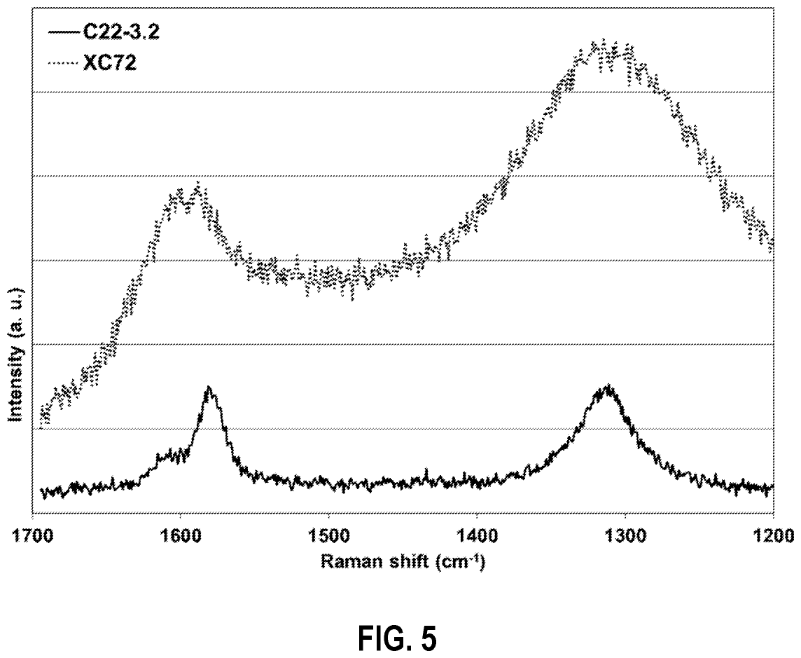

In some embodiments, the cathode (e.g., produced via the process 100) may include a sulfur-based material (e.g., a sulfur-based cathode active material). In additional or alternative embodiments, the cathode may include a carbon-based cathode active material, such as graphite or another carbon-based material. In an exemplary embodiment, the cathode may include, consist essentially of, or consist of graphite, sulfur, polyvinyl acetate (PVA), and/or urethane. In at least one implementation, graphite may be obtained from a sugar and ammonium chloride reaction. In at least one implementation, PVA may be replaced by another binder, such as polytetrafluoroethylene (PTFE) and/or polyvinylidene fluoride (PVDF). In at least one implementation, a minimal amount of binders (e.g., a relatively small amount of binders or no binders at all) may be present in the cathode, e.g., to improve electrochemical performance. In a specific experiment to make a cathode, a mixture of sugar and ammonium chloride (weight ratio of 1:1) was mixed in a crucible and calcined under a CO₂ blanket by heating to 250° C. at 4° C./min and holding for 10 minutes. A resultant material was cooled to room temperature, then re-calcinated by heating to 800° C. at 20° C./min and holding for 1 hour. The XRD of the resultant synthesized graphite (C22-3.2-Full) is shown in FIG. 4. C22-3.2-Full displays a typical graphite XRD pattern. As a comparison, the Vulcan XC-72 carbon black is also shown in FIG. 4. The Raman spectrum of the synthesized graphite is shown in FIG. 5, in which the Vulcan XC-72 carbon black is also presented as a reference. Measurements were made with a 785 nm excitation source. The D/G ratios are 1.02 for C22-3.2-Full and 1.42 for Vulcan XC-72. In this example cathode, sulfur may be a cathode reactive material (also referred to herein as a cathode active material). In certain embodiments, the graphite may be an electric conductor; however, the graphite may also provide some capacity. In various examples, the D/G ratio may be an indicator of the graphite materials but not a restriction on selection of the materials. In certain embodiments, PVA and urethane may be binders. For example, during a charging/discharging process, PVA and urethane may cross-link to form rigid confinement structures to prevent diffusion of polysulfides away from the cathode.

In at least one embodiment, the process 100 may include forming the SSE (e.g., the SSE 2420) by combining 122 one or more second ingredients (e.g., a mixture of salts, such as urea, sodium chloride, sodium borate, magnesium sulfate, and/or sodium silicate) in (aqueous) suspension, applying 124 the suspension to a cellulose membrane, and drying 126 the coated cellulose membrane.

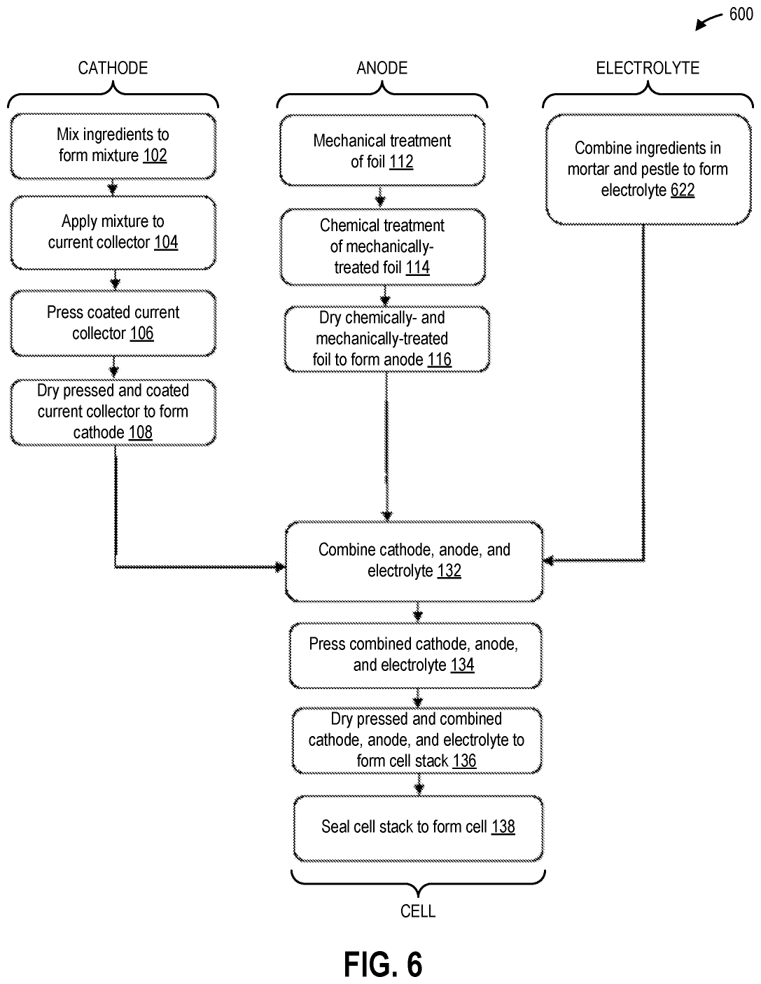

The process of forming the SSE may also be realized, for example, by dry mixing, as shown in process 600 of FIG. 6. Specifically, in the process 600, though formation of the cathode and the anode may be the same, or substantially the same, as in the process 100 of FIG. 1, formation of the SSE may include, instead of the combining 122, the applying 124, and the drying 126, combining 622 the one or more second ingredients in mortar and pestle.

The SSE in various embodiments may include a mixture of salts including urea, sodium chloride, sodium borate, magnesium sulfate, and/or sodium silicate. In additional or alternative examples, the mixture of salts may include potassium chloride. As a proof-of-concept example, urea, sodium chloride, sodium borate, and magnesium sulfate were mixed with an equal, or substantially equal, mass amount of powders (when the term “substantially” is used herein, it is meant that the recited relationship, characteristic, parameter, or value need not be realized with exact precision, but that deviations or variations known to those of skill in the art may occur to an extent that does not preclude the effect the relationship, characteristic, parameter, or value was intended to provide). In certain embodiments, a concentration of each component may be varied. In certain embodiments, during charge/discharge, abundant chloride in the SSE may form Al—Cl compounds. In presence of urea, a localized ionic liquid could be formed to transfer ions such as Al₂Cl₇⁻ and AlCl₄⁻. Thus, a total amount of NaCl and urea in this example may account for 50 wt %-95 wt % of an (initial) SSE mixture with an atomic ratio of NaCl:urea equal to or greater than 1. In certain embodiments, the sodium borate may be an effective additive to form a robust SEI layer. The sodium borate in this example may account for 0.1 wt %-25 wt % of the (initial) SSE mixture. In certain embodiments, the magnesium sulfate may increase a viscosity of the localized ionic liquid to form a close-to-solid (e.g., a quasi-solid or semisolid) SSE. Thus, the MgSO₄ in this example may be 0.1 wt %-25 wt % of the (initial) SSE mixture. In certain embodiments, the sodium silicate may be an additive, e.g., to disturb crystallization of the salts and increase ionic conductivity. The sodium silicate in this example may be in the range of 0.1 wt %-10 wt % of the (initial) SSE mixture. The mixing of the salts and/or other materials in the initial SSE mixture may be either dry mixing or wet mixing. In FIG. 1, an example process of wet mixing is shown.

In at least one embodiment, either the process 100 of FIG. 1 or the process 600 of FIG. 6 may include forming the cell (e.g., the cell 2430) by combining 132 (e.g., layering) the cathode, the anode, and the SSE, pressing 134 the combined cathode, anode, and SSE, drying 136 the pressed and combined cathode, anode, and SSE to form a cell stack, and sealing 138 the cell stack (e.g., in the pouch 2432).

To make the cell by dry mixing (e.g., via the process 600 of FIG. 6), in one example implementation, the SSE (e.g., in the form of a powder mixture) may be placed between the anode and the cathode. Once placed, in at least one such implementation, the combined cathode, anode, and SSE may be compressed using a hydraulic press, then dried. Once dried, in at least one such implementation, the cell (e.g., in the form of an unpackaged cell stack) may be sealed into a pouch. To make the cell by wet mixing (e.g., via the process 100 of FIG. 1), in one example implementation, a suspension may be initially prepared by mixing SSE ingredients (e.g., urea, sodium chloride, sodium borate, and magnesium sulfate in equal mass ratios in a deionized water suspension). In at least one such implementation, the suspension may be used to saturate a 150-micron-thick cellulose membrane with a porosity of 1.1 g/4″×4″. A composition, a thickness, and a porosity of the membrane may be varied in further embodiments. The composition in some examples may include any suitable material that is an electrical insulator including but not limited to cellulose. The thickness in some embodiments may be from 1 micron to 500 microns. In certain embodiments, the thickness may be between 10 microns and 100 microns. In at least one implementation, a minimum thickness of the cellulose membrane (e.g., at least thick enough to not substantially sacrifice electrochemical performance) may be utilized. The porosity in various embodiments may be varied from 10% to 90% by volume. In certain embodiments, the porosity may be between 60% to 90% by volume. In at least one implementation, a maximum porosity of the cellulose membrane (e.g., while still retaining structural integrity) may be utilized. The saturated membrane, in at least one such implementation, may be dried to create a thin SSE layer embedded in the cellulose membrane. The thin SSE layer, in at least one such implementation, may be wet with a sodium silicate solution in which the sodium silicate accounts for less than 1 wt % of the SSE, before being placed between a previously treated anode (e.g., treated as described hereinabove) and a previously prepared cathode (e.g., prepared as described hereinabove). Once combined, in at least one such implementation, the anode, the SSE, and the cathode may be compressed using a hydraulic press, and then dried. Once dried, in at least one such implementation, the cell may be sealed into a pouch.

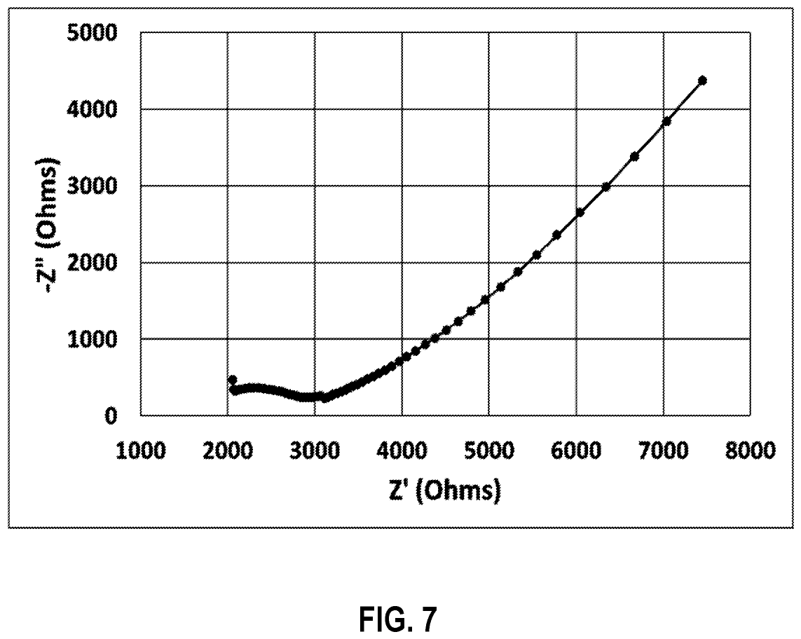

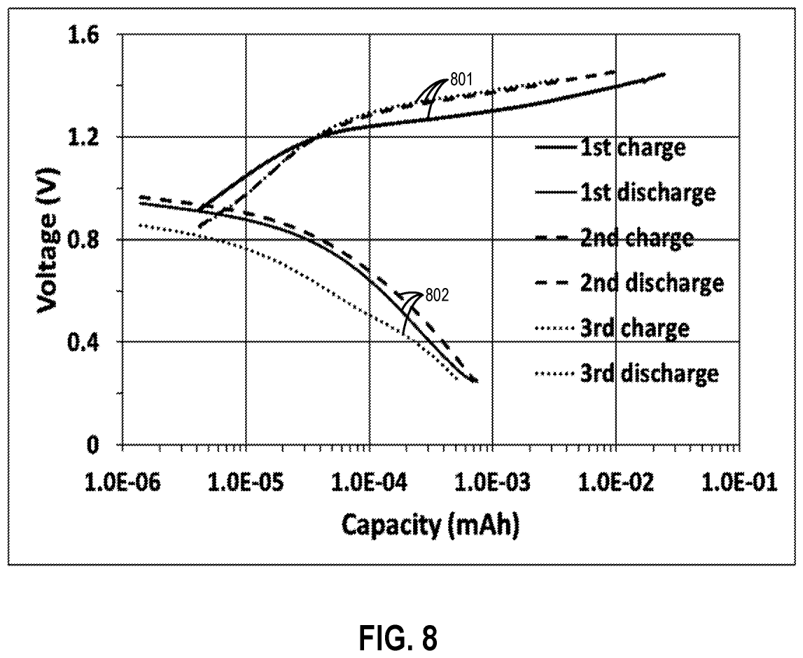

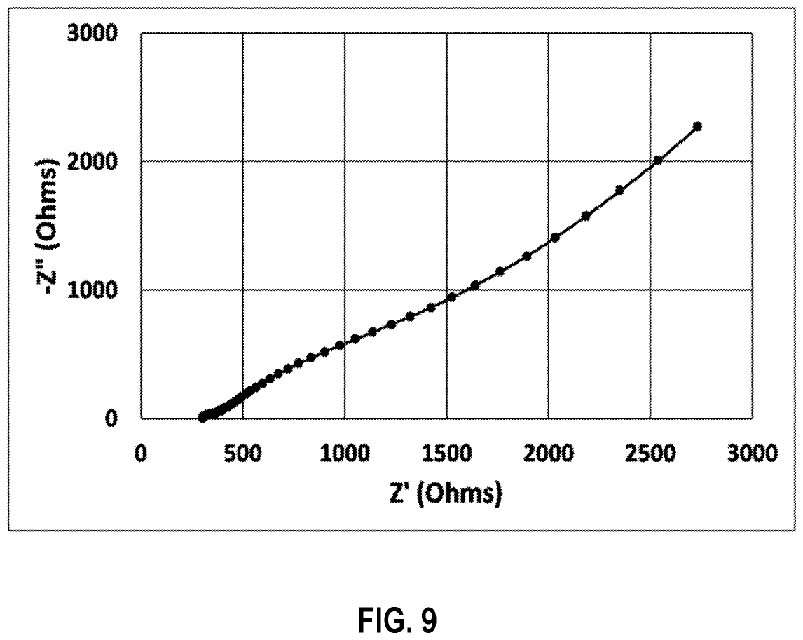

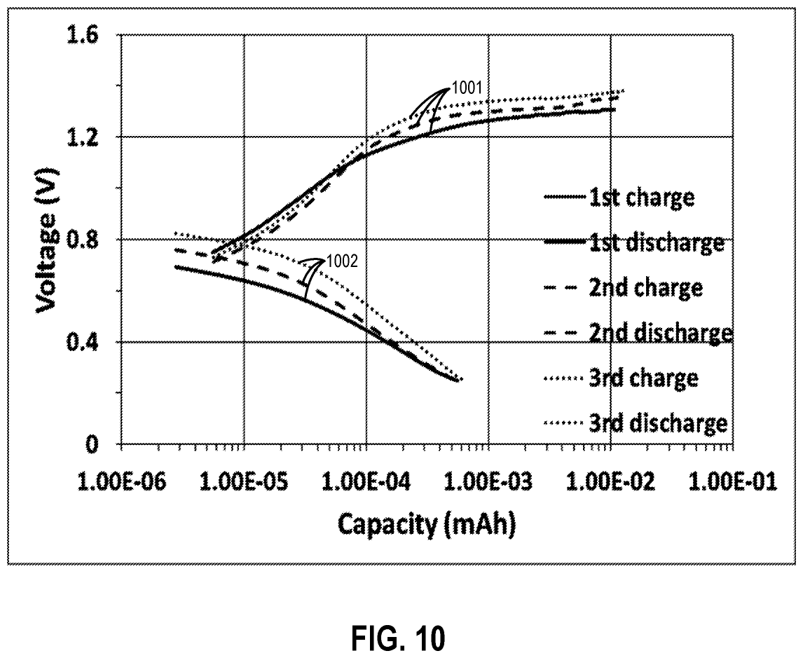

In an example implementation, an assembled cell, e.g., a cell assembled using the process 100 of FIG. 1, displayed a high impedance of ˜3100 Ohms (see FIG. 7). Although the impedance was high in this example, the cell was able to cycle (see FIG. 8, showing charge curves 801 and discharge curves 802). To generate the charge and discharge curves 801, 802 of FIG. 8, the cell was charged in this example by a 0.015 mA constant current and discharged by a 0.005 mA current. To mitigate the high impedance (e.g., >500 Ohms), acetone was injected into the cell in this example. After acetone injection, the cell impedance immediately dropped to less than 500 Ohms in this example (see FIG. 9). The cycling performance was also dramatically improved after acetone injection in this example (see FIG. 10, showing charge curves 1001 and discharge curves 1002). To generate the charge and discharge curves 1001, 1002 of FIG. 10, the cell was charged in this example by a 0.02 mA constant current and discharged by a 0.01 mA constant current. A discharge voltage in this example increased while polarization reduced during cycling. The cell charge/discharge curves described hereinabove demonstrate that the example cells made from powder mixing may possess a large impedance that may be caused by a thick SSE layer and a porous structure thereof. FIGS. 7-10 indicate that cells made as described hereinabove be cycled, even while having a high impedance (e.g., >500 Ohms), which validates such cell design and SSE design for Al-based secondary batteries. Adding liquids such as acetone may mitigate the high impedance to some extent in various embodiments. However, the high impedance may remain an issue in some examples. In certain embodiments, the high impedance may be attributed to both chemical and physical properties of the SSE. For the chemical properties, the composition or the materials of the SSE may be adjusted or redesigned to improve ionic conductivity in some examples. For the physical properties, the porosity of the SSE may be high in some examples due to mechanical pellet pressing at room temperature. Moreover, the thickness of the SSE may be difficult to reduce in certain powder processing examples. One or more of the preceding factors may lead to high impedance of the cell in some embodiments.

### The Slot-Die Process of Some Embodiments

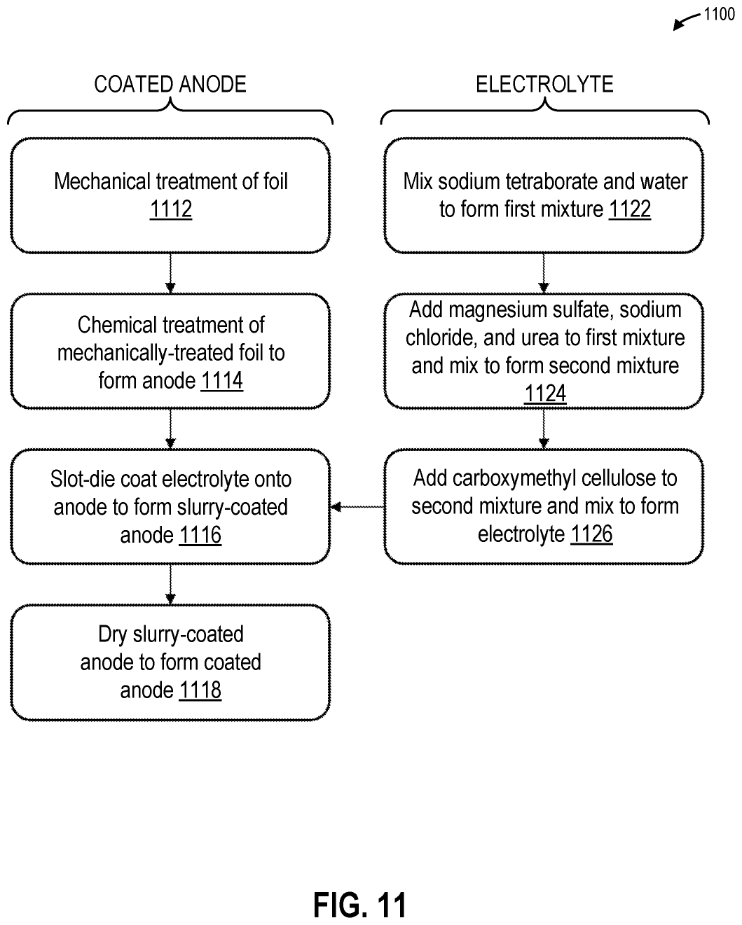

As powder processing may not always result in a thin and dense film in some embodiments, other embodiments include a scalable process based on slot-die coating to make the SSE. An example process 1100 for slurry preparation is depicted in FIG. 11. In at least one embodiment, the process 1100 may include forming the SSE (e.g., the SSE 2420 of FIG. 24) by mixing 1122 sodium tetraborate and water to form a first mixture, adding 1124 magnesium sulfate, sodium chloride, and urea to the first mixture and mixing to form a second mixture, and adding 1126 CMC to the second mixture and mixing to form the SSE. In at least one embodiment, the process 1100 may include forming an anode (e.g., the anode 2410 of FIG. 24) to be slurry coated with the SSE by mechanically treating 1112 a metal foil (e.g., the metal foil 2412) and chemically treating 1114 the mechanically-treated foil to form the anode. In at least one embodiment, the process 1100 may include slurry coating the anode with the SSE by slot-die coating 1116 the SSE onto the anode to form a slurry-coated anode and drying 1118 the slurry-coated anode to form a coated anode (e.g., ready to be stacked with a SSE layer and a cathode during assembly of a cell).

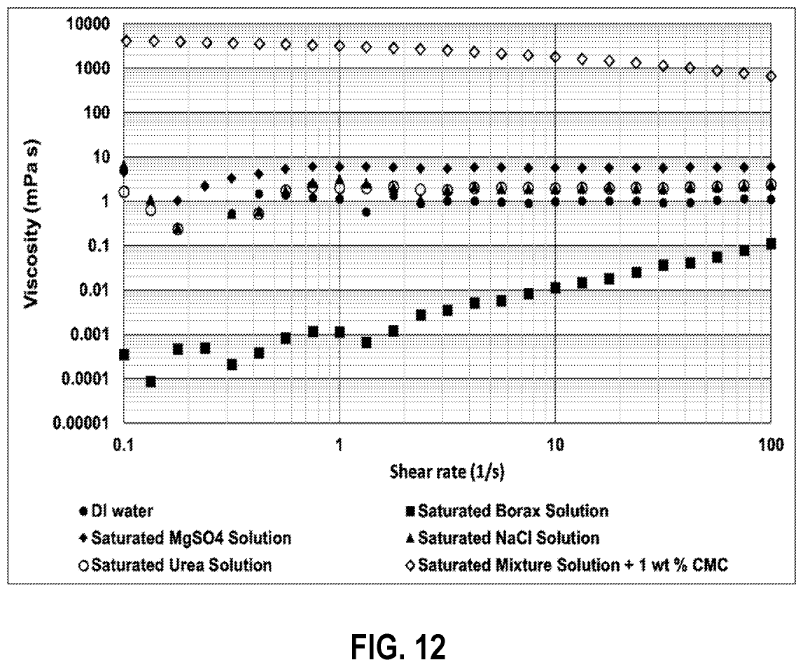

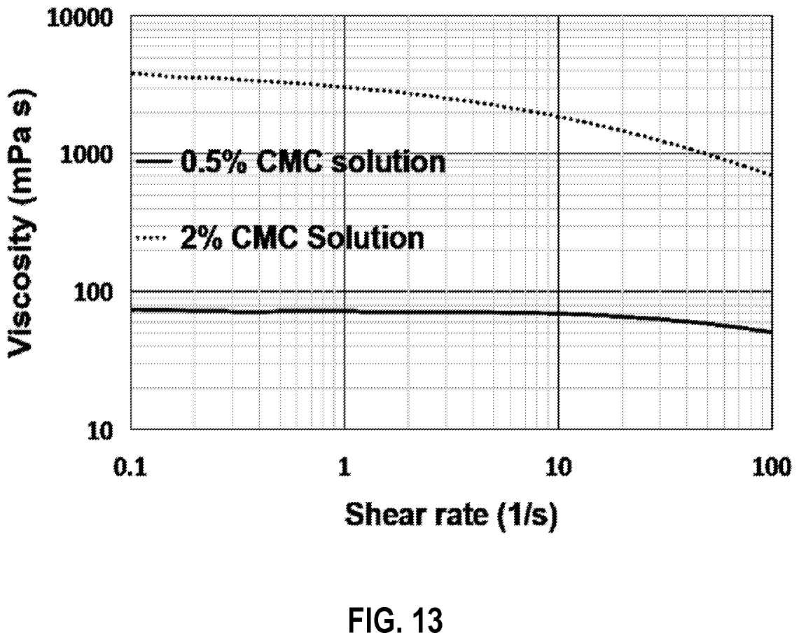

In some embodiments of the slot-die process, the SSE components may first be dissolved/dispersed in a slurry with CMC as a thickener. The resultant slurry in various examples may still be flowable or below a maximal viscosity one or more instruments used during processing may handle. However, each component of the slurry may have a different effect on the viscosity (e.g., of the final SSE) in various embodiments. For example, in some implementations, certain saturated urea, sodium chloride, sodium borate, and magnesium sulfate slurries may display similar viscosities compared to water. A slurry in some implementations including saturated urea, sodium chloride, sodium borate, magnesium sulfate, and 1 wt % CMC displays a significantly higher viscosity than other solutions/dispersions/slurries (see, e.g., FIG. 12). Based on FIGS. 12 and 13, CMC may be a desirable component to increase viscosity in some embodiments. For example, an overall viscosity of the solution from which the slurry is prepared in various embodiments may be significantly increased with increasing CMC concentration from 0.5 wt % to 2 wt % (see FIG. 13). In various example experiments, 2 wt % CMC may be added to the slurry mixture. In other example experiments, 1 wt % CMC may be added to the slurry mixture. Although CMC-based solutions may be diluted when mixing with other components, such dilutions may improve flowability of the slurry in some examples without reducing dispersibility of every component in the slurry.

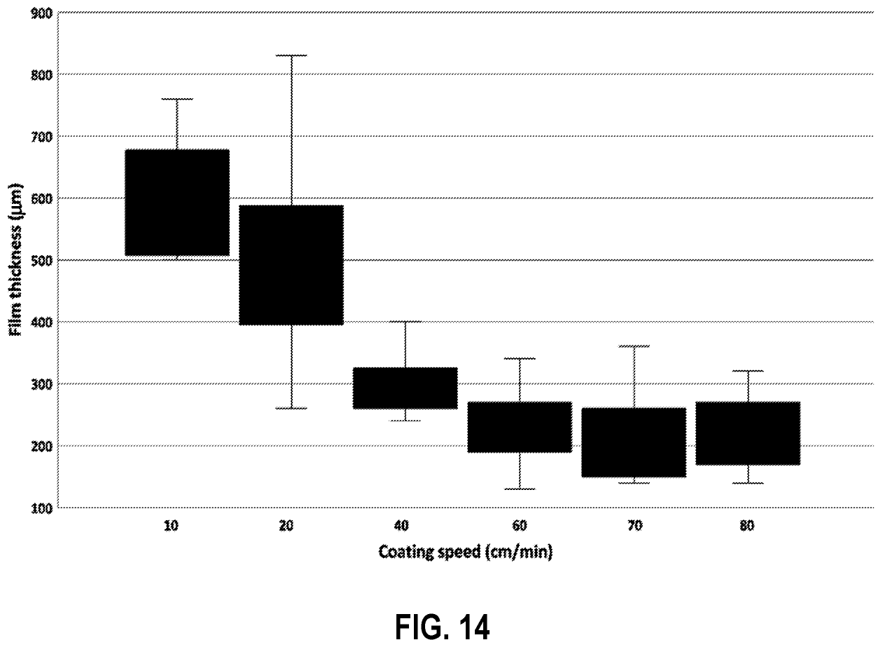

In one example implementation, a slurry, e.g., a slurry obtained via the mixing 1122, adding 1124, and adding 1126 of the process 1100 of FIG. 11, may be used for slot-die coating. A coating speed of the slot-die coating may have a significant effect on thickness of a resultant film in some embodiments. In a specific example implementation, a slurry including 15.5 wt % urea, 15.5 wt % MgSO₄, 15.5 wt % NaCl, 1 wt % sodium tetraborate, 1 wt % CMC, and 51.6 wt % water was coated on a substrate (aluminum foil in this specific example implementation, though other substrates may be used in other example implementations). As shown in FIG. 14, once the coating speed of the slot-die coating exceeds 40 cm/min, in some examples the coating thickness may reach a steady state of ˜250 microns and may display less variation. Compared to powder processing, in some embodiments, the slot-die coating may deliver a thinner film with better film quality regarding mechanical strength and ease of use of repeated pellet pressing and annealing. However, the slurry coating in some examples (e.g., via the process 1100 of FIG. 11) may be easily applied to industrial-scale manufacturing. Other coating parameter(s) (e.g., viscosity) may also be varied based on the slurry (e.g., a composition thereof).

In one specific slot-die coating experiment, a pre-treated aluminum foil was coated using the following parameters and a slurry including 15.5 wt % urea, 15.5 wt % MgSO₄, 15.5 wt % NaCl, 1 wt % sodium tetraborate, 1 wt % CMC, and 51.6 wt % water. The slurry in this example showed a viscosity similar to the saturated mixture solution (+1 wt % CMC) shown in FIG. 12. The coating speed may be 20-40 cm/min in some examples. For instance, the coating speed may be 30 cm/min. A pumping rate may be 5000-10000 μL/min in some examples. For instance, the pumping rate may be 10000 μL/min. Pre-start pump time may be 3 seconds in some examples. Pre-end stop time may be 1 second in some examples. The coating may deliver a film in some embodiments with dimensions of 200 mm long, 100 mm wide, and 350 μm thick.

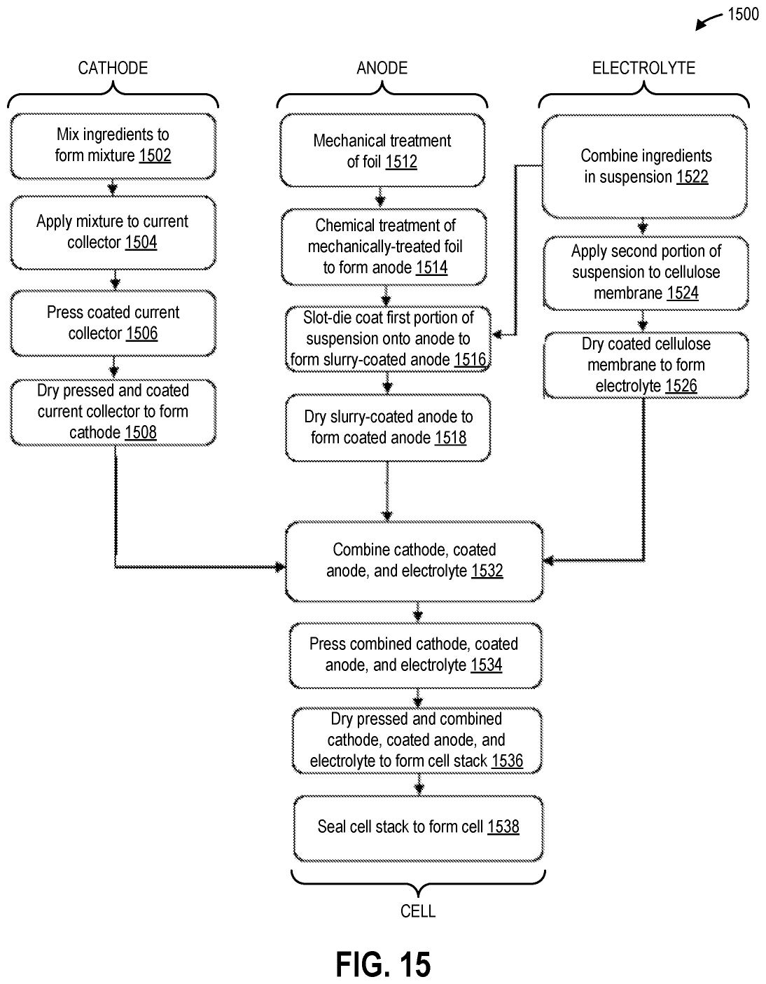

An example of a process 1500 of making a cell by slot-die coating an SSE is presented in FIG. 15. In some embodiments, the process 1500 may include forming a cathode, an anode, and an SSE, and forming a cell. In at least one embodiment, the process 1500 may include forming a cathode, an anode, and an SSE, slot-die coating the anode with at least a portion of the SSE, and forming a cell from the cathode, the coated anode, and the SSE.

In at least one embodiment, the process 1500 may include forming the cathode (e.g., the cathode 2400 of FIG. 24) by mixing 1502 one or more first ingredients (e.g., graphite, sulfur, polyvinyl acetate, and/or urethane) to form a mixture, applying 1504 the mixture to a current collector (e.g., the current collector 2402 of FIG. 24), pressing 1506 the coated current collector, and drying 1508 the pressed and coated current collector (e.g., thereby forming a cathode active material layer, such as the cathode active material layer 2404 of FIG. 24, on the current collector via the applying 1504, the pressing 1506, and the drying 1508). Accordingly, in such embodiments, formation of the cathode may be the same, or substantially the same, as in the process 100 of FIG. 1 or the process 600 of FIG. 6.

In at least one embodiment, the process 1500 may include forming the anode (e.g., the anode 2410 of FIG. 24) by mechanically treating 1512 a metal foil (e.g., the metal foil 2412 of FIG. 24) and chemically treating 1514 the mechanically-treated foil.

In at least one embodiment, the process 1500 may include forming a slurry including component(s) of the SSE by combining 1522 one or more second ingredients (e.g., a mixture of salts, such as urea, sodium chloride, sodium borate, magnesium sulfate, and/or sodium silicate) in aqueous suspension.

In at least one embodiment, the process 1500 may include forming the coated anode by receiving the anode formed by mechanically treating 1512 and chemically treating 1514 the metal foil, receiving a first portion of the suspension formed by combining 1522 the one or more second ingredients, slot-die coating 1516 the first portion of the suspension onto the anode to form a slurry-coated anode, and drying 1518 the slurry-coated anode to form the coated anode.

In at least one embodiment, the process 1500 may include forming the SSE (e.g., the SSE 2420 of FIG. 24) by applying 1524 a second portion of the suspension to a cellulose membrane and drying 1526 the coated cellulose membrane.

In at least one embodiment, the process 1500 may include forming the cell (e.g., the cell 2430 of FIG. 24) by combining 1532 (e.g., layering) the cathode, the coated anode, and the SSE, pressing 1534 the combined cathode, coated anode, and SSE, drying 1536 the pressed and combined cathode, anode, and SSE to form a cell stack, and sealing 1538 the cell stack (e.g., in the pouch 2432 of FIG. 24) to form the cell.

In some embodiments, the cathode (e.g., produced via the process 1500) may include a sulfur-based material. In an exemplary embodiment, the cathode may include, consist essentially of, or consist of graphite, sulfur, PVA, and/or urethane. The metal foil, which in certain embodiments may be an aluminum foil, may be abrased in some example implementations and then reacted with HCl solution in such example implementations. In one such example implementation, such as in the process 1500, the (mechanically and chemically) treated aluminum foil may be used as a substrate for slot-die coating. A slurry (e.g., for slot-die coating the treated aluminum foil) in this example implementation may include 15.5 wt % urea, 15.5 wt % MgSO₄, 15.5 wt % NaCl, 1 wt % sodium tetraborate, 1 wt % CMC, and 51.6 wt % water. After coating the slurry on the treated Al foil, a sodium silicate solution, with sodium silicate accounting for less than 1 wt % of the slurry, may be added to a resultant film. In some embodiments, a solution, a suspension, or a slurry including 15.5 wt % urea, 15.5 wt % MgSO₄, 15.5 wt % NaCl, 1 wt % sodium tetraborate, 1 wt % CMC, and 51.6 wt % water may be used to saturate a cellulose membrane with a porosity of 1.1 g/4″×4″. A composition, a thickness, and a porosity of the membrane may be varied in some embodiments. The composition of various embodiments may include any suitable material that is an electrical insulator including but not limited to cellulose. The thickness in some embodiments may be from 1 micron to 500 microns. The porosity may be varied from 10% to 90% by volume in various examples. The saturated membrane, in at least one such implementation, may be dried to create a SSE layer embedded in the cellulose membrane. In at least one such implementation, such as in the process 1500, the cathode, the dried and SSE-embedded cellulose membrane (also referred to as the SSE), and slot-die-coated Al foil (also referred to as the coated anode) may be stacked together. Once combined, in at least one such implementation, the coated anode, the SSE, and the cathode may be compressed using a hydraulic press, and then dried. Once dried, in at least one such implementation, the cell may be sealed into a pouch.

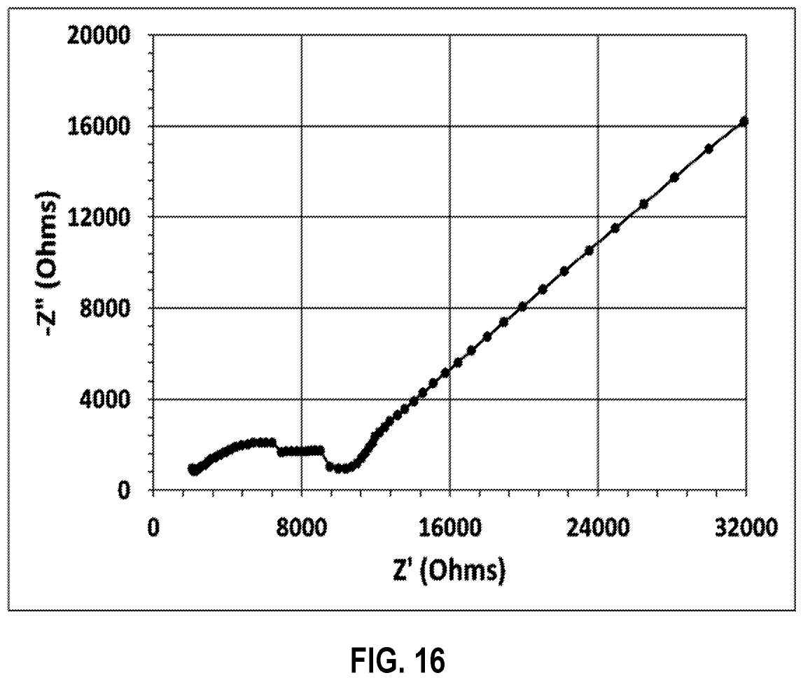

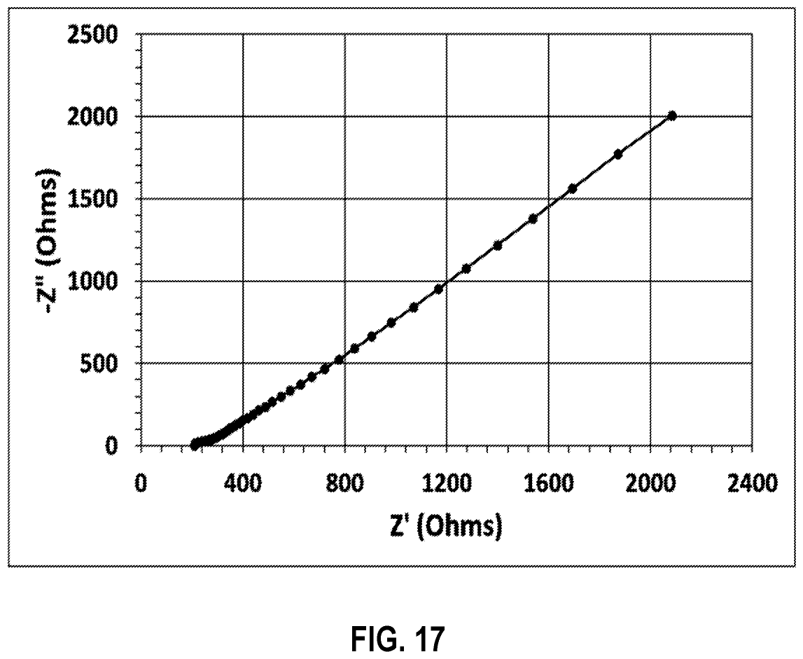

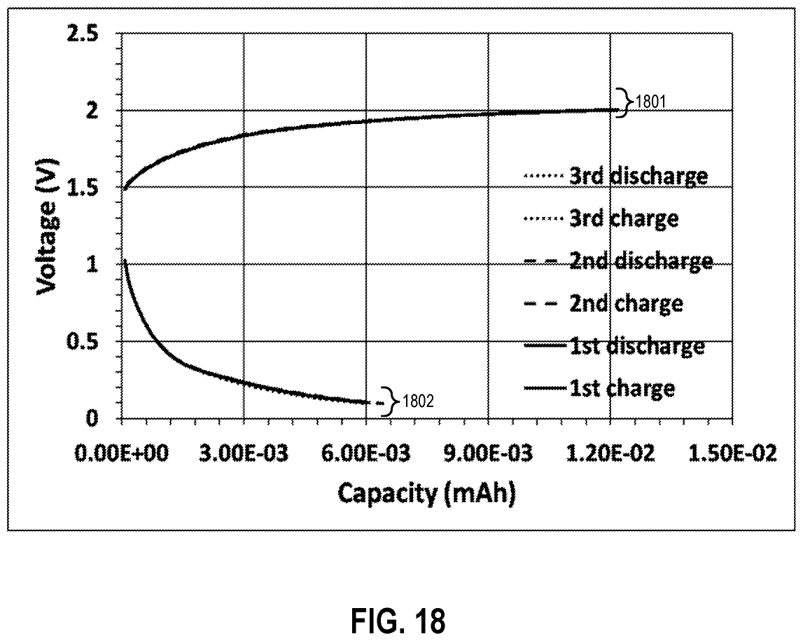

An as-built cell of one such example implementation exhibited high impedance. A total resistance in this example was 10,000 Ohms (see FIG. 16). In this example, after applying 0.01 mA to the cell for 2 hours, the impedance was reduced to less than 300 Ohms (see FIG. 17). Accordingly, the cell in this example became cyclable after being charged for 1 hour. The cell in this example implementation was then charged/discharged by a constant current of 0.05 mA. The charge/discharge curves (see FIG. 18, showing charge curves 1801 and discharge curves 1802) show that the impedance remained high in this example. However, and as shown in FIG. 18, the charge and discharge curves 1801, 1802 were identical during three cycles in this example, which may indicate that in various embodiments a constant charge at 0.01 mA may activate the cell by creating conduction pathways. Establishment of such pathways may enhance charge transfer and may stabilize the cycling in various examples. In some example implementations, the slot-die may provide a better-quality SSE film, e.g., having composition uniformity over a substrate and a thin film thickness. However, adding CMC in some examples may exaggerate low ionic conductivity. In various embodiments, one or both CMC and the salts included in the SSE may be hydrophilic. In some examples, absorption of moisture into the cell may not be eliminated during storage and testing.

### Pulse Charging to Create an In Situ SEI Layer in Some Embodiments

In one example experiment, a unique charging protocol may be utilized to create an in situ SEI layer between an electrode and an electrolyte (e.g., a pair of in situ SEI layers, such as the in situ SEI layers 2440, 2442 of FIG. 24, respectively interposed between a cathode and an SSE layer and an anode and the SSE layer). In some examples involving powder mixing, a resultant SSE wafer may be porous and brittle. Additionally or alternatively, ionic conduction pathways may not be well-formed in the SSE in some embodiments. In the process 600 of FIG. 6, for example, sodium silicate may be an inorganic binder which may, in some embodiments, facilitate formation of an improved SSE wafer, e.g., with lower porosity and/or higher mechanical strength. In contrast, cells built from a powder mixture without sodium silicate may exaggerate issues ascribable to highly porous SSE and a resultant high impedance in certain embodiments. However, various embodiments may be improved by applying high current and/or voltage to mitigate such issues. Accordingly, in one example implementation, the process 600 of FIG. 6 may be applied but without adding sodium silicate.

In one example implementation, the cell was built as follows: a plurality of (SSE) ingredients, including urea, sodium chloride, sodium borate, and magnesium sulfate, were combined in equal mass ratios in a mortar and pestle to form a powder; the combined powder was placed, in a thin layer, between a previously treated anode (e.g., treated as described in detail above with reference to FIG. 6) and a previously prepared cathode (e.g., prepared as described in detail above with reference to FIG. 6); once combined, the anode, the SSE, and the cathode were compressed using a hydraulic press, and then dried; and, once dried, the cell was sealed into a pouch.

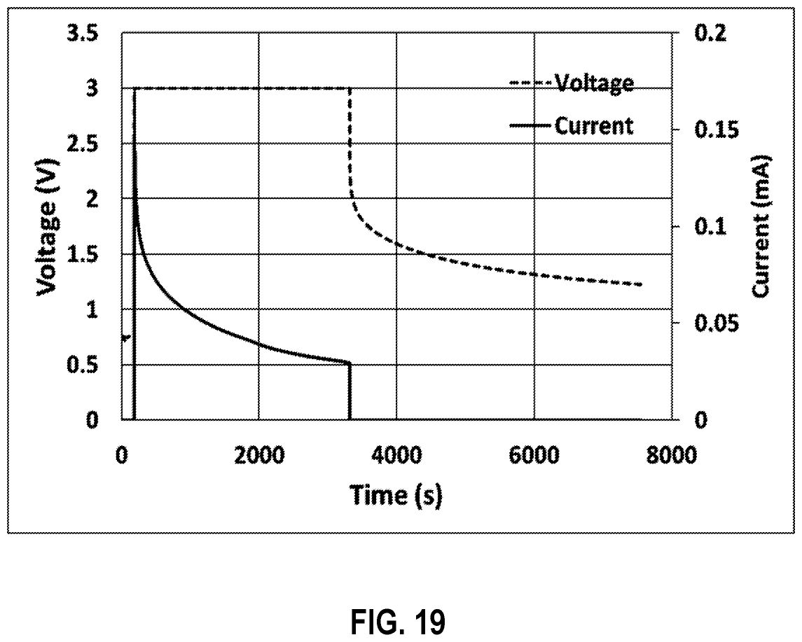

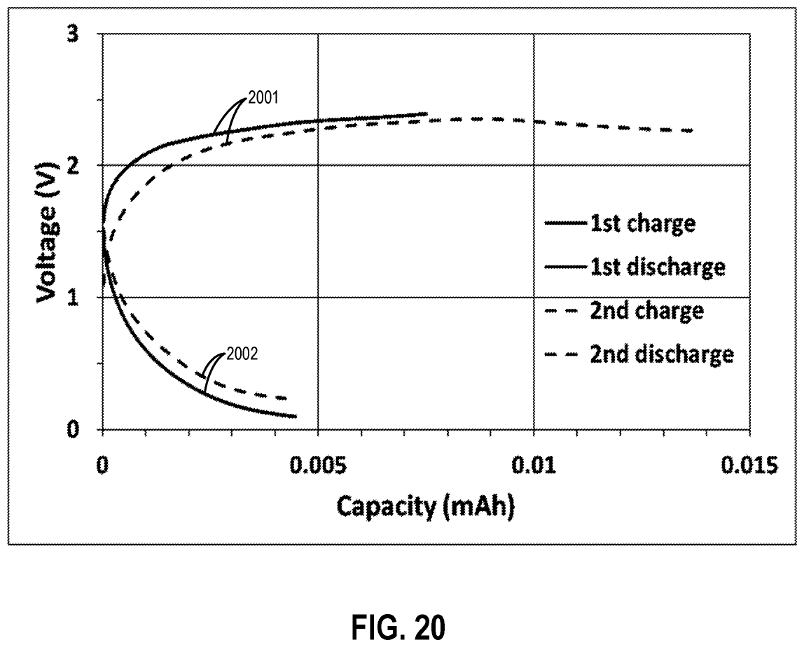

After building the cell, in this example, 3 V was applied to the cell for ˜1 hour (see FIG. 19). A rapid voltage drop observed in this example may indicate high impedance. Then, in this example, the cell was cycled at 0.01 mA (see FIG. 20, showing charge curves 2001 and discharge curves 2002). During cycling, the impedance remained high in this example (however, was nevertheless able to be cycled).

In another example implementation, a cell was built using a slot-die process, such as the process 1500 of FIG. 15, without addition of CMC, as follows: a plurality of (SSE) ingredients, including urea, sodium chloride, sodium borate, and magnesium sulfate, were combined in equal mass ratios in a deionized water suspension; the suspension was used to saturate a cellulose membrane with a porosity of 1.1 g/4″×4″; the saturated membrane was dried to create a SSE layer embedded in the cellulose membrane; the SSE layer was then wet with 1 mol/L NaOH solution such that the NaOH accounts for less than 1 wt % of a resultant slurry, before being placed between a previously treated anode (e.g., treated as described in detail above with reference to FIG. 15) and a previously prepared cathode (e.g., prepared as described in detail above with reference to FIG. 15); once combined, the anode, the SSE, and the cathode were compressed using a hydraulic press, and then dried; and, once dried, the cell was sealed into a pouch. Without CMC, in some embodiments, binding between various components of the SSE and/or between the SSE layer and the anode and/or the cathode may be poor.

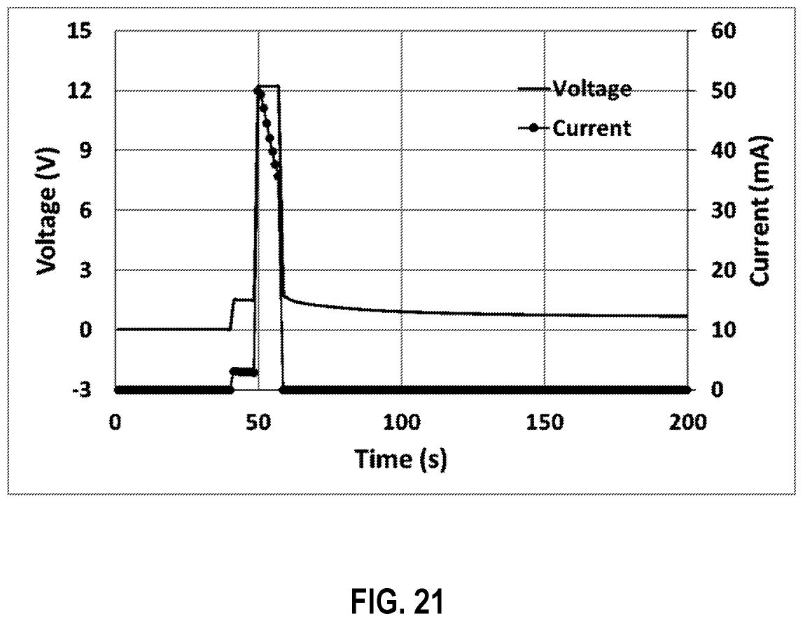

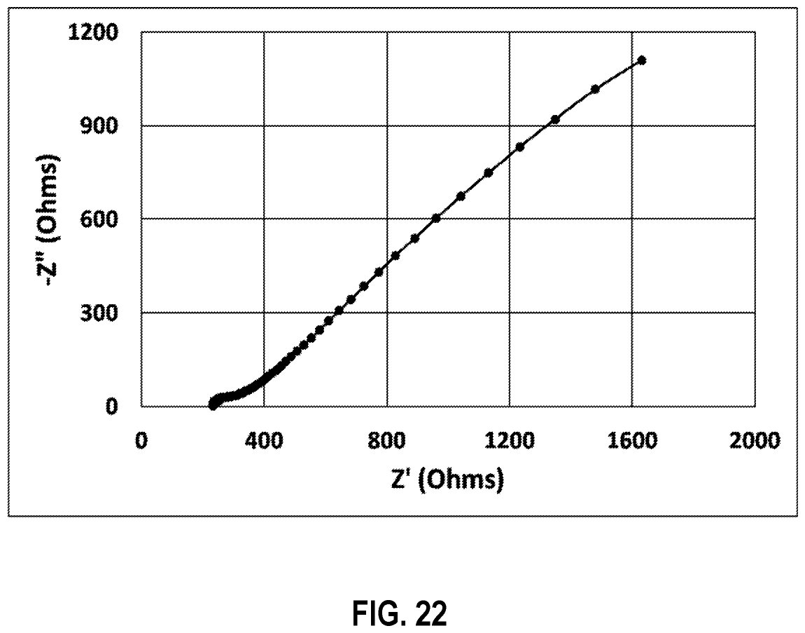

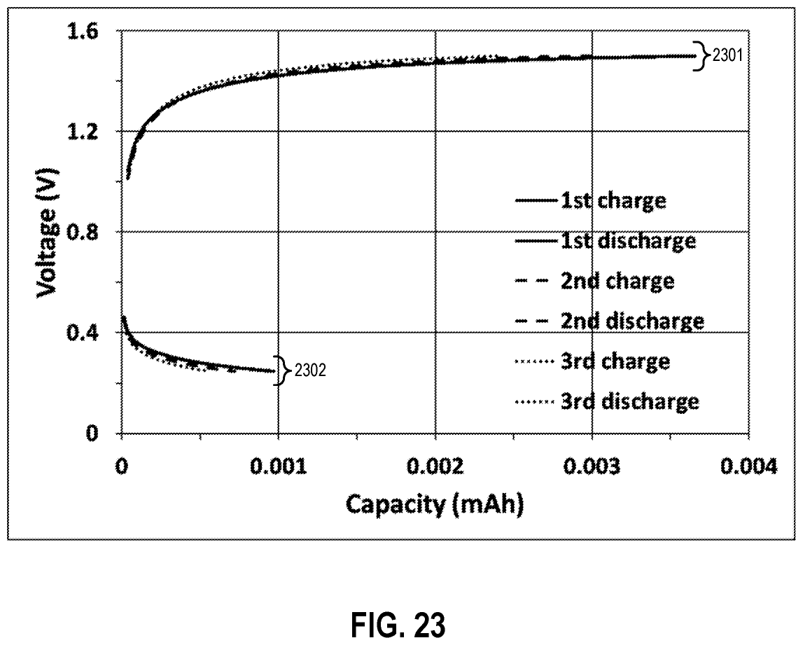

In this example, the assembled cell displayed an open circuit voltage (OCV) of 0.01 V and infinite direct current (DC) resistance as measured by a multifunctional meter. As a SSE film made from a slot-die process may be thinner than a SSE layer obtained via powder mixing and pressing in some examples, a current pulse was applied instead of a constant voltage. In some examples, the pulse may be applied at 10-100 mA. In this example, the pulse was applied at 50 mA. After the pulse, in this example, the OCV increased to 0.62 V (see FIG. 21), indicating that cell impedance before the pulse may have been too high to conduct the current. After the pulse, in this example, the impedance was reduced to a cyclable level of <400 Ohms (see FIG. 22). In this example, the cell was charged by 0.15 mA and discharged by 0.05 mA constant currents (see FIG. 23, showing charge curves 2301 and discharge curves 2302). The charge and discharge curves 2301, 2302 of FIG. 23 may indicate the importance of implementing an activation step by the current pulse in various embodiments.

Such data illustrate that embodiments of compositions of the SSE and methods associated therewith may be used for rechargeable Al batteries (e.g., secondary batteries including Al). In some embodiments, high impedance (e.g., >500 Ohms) may be mitigated by activation steps, such as applying a constant voltage and/or a current pulse prior to cycling. The activation step in various examples may promote formation of ionic conduction pathways to facilitate charge transfer.

The specification and drawings are to be regarded in an illustrative rather than a restrictive sense. It will, however, be evident that various modifications and changes may be made thereunto without departing from the broader spirit and scope of the invention as set forth in the claims. That is, the described embodiments are susceptible to various modifications and alternative forms, and specific examples thereof have been shown by way of example in the drawings and are herein described in detail.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

Embodiments of the present disclosure can be described in view of the following clauses:

1. A solid-state electrolyte composition, comprising:
a mixture comprising urea, sodium chloride, sodium tetraborate, magnesium sulfate, and sodium silicate, wherein:
   a total amount of the urea and the sodium chloride accounts for 50 wt % to 95 wt % of the mixture;
   a total amount of the sodium tetraborate accounts for 0.1 wt % to 25 wt % of the mixture;
   a total amount of the magnesium sulfate accounts for 0.1 wt % to 25 wt % of the mixture;
   a total amount of the sodium silicate accounts for 0.1 wt % to 10 wt % of the mixture; and
   an atomic ratio of sodium chloride to urea is equal to or greater than 1.

2. The solid-state electrolyte composition of clause 1, wherein the solid-state electrolyte composition is an aqueous slurry.

3. The solid-state electrolyte composition of any one of clauses 1 or 2, wherein a total amount of the sodium silicate accounts for less than 1 wt % of the aqueous slurry.

4. The solid-state electrolyte composition of any one of clauses 1-3, further comprising carboxymethyl cellulose, wherein a total amount of the carboxymethyl cellulose accounts for 0.5 wt % to 2 wt % of the aqueous slurry.

5. The solid-state electrolyte composition of any one of clauses 1-4, wherein:
a total amount of the urea accounts for 15.5 wt % of the aqueous slurry;
a total amount of the sodium chloride accounts for 15.5 wt % of the aqueous slurry;
a total amount of the sodium tetraborate accounts for 1 wt % of the aqueous slurry;
a total amount of the magnesium sulfate accounts for 15.5 wt % of the aqueous slurry;
the total amount of the carboxymethyl cellulose accounts for 1 wt % of the aqueous slurry; and
a total amount of water accounts for 51.6 wt % of the aqueous slurry.

6. A method for forming an aluminum-based secondary battery, the method comprising:
forming a cathode by:
   applying a sulfur-based mixture to coat a current collector;
   pressing the coated current collector; and
   drying the pressed and coated current collector to form a sulfur-based cathode active material layer thereon;
forming an anode by mechanically and chemically treating an aluminum foil;
forming a suspension by combining urea, sodium chloride, sodium tetraborate, magnesium sulfate, and sodium silicate;
forming a coated anode by:
   slot-die coating a first portion of the suspension onto the anode; and
   drying the slot-die coated anode;
forming a solid-state electrolyte by:
   applying a second portion of the suspension to coat a cellulose membrane; and
   drying the coated cellulose membrane;
combining and pressing the cathode, the coated anode, and the solid-state electrolyte;
drying the pressed and combined cathode, coated anode, and solid-state electrolyte to form a cell stack; and
sealing the cell stack in a pouch.

7. The method of clause 6, wherein the urea, the sodium chloride, the sodium tetraborate, the magnesium sulfate, and the sodium silicate are combined as a mixture prior to forming the suspension, wherein:
a total amount of the urea and the sodium chloride accounts for 50 wt % to 95 wt % of the mixture;
a total amount of the sodium borate accounts for 0.1 wt % to 25 wt % of the mixture;
a total amount of the magnesium sulfate accounts for 0.1 wt % to 25 wt % of the mixture;
a total amount of the sodium silicate accounts for 0.1 wt % to 10 wt % of the mixture; and
an atomic ratio of sodium chloride to urea is equal to or greater than 1.

8. The method of any one of clauses 6 or 7, wherein forming the suspension comprises:
mixing the sodium tetraborate and water to form a first mixture;
adding the magnesium sulfate, the sodium chloride, and the urea to the first mixture and mixing to form a second mixture; and
adding carboxymethyl cellulose to the second mixture.

9. The method of any one of clauses 6-8, wherein a total amount of the carboxymethyl cellulose accounts for 0.5 wt % to 2 wt % of the suspension.

10. The method of any of clauses 6-9, wherein:
a total amount of the urea accounts for 15.5 wt % of the suspension;
a total amount of the sodium chloride accounts for 15.5 wt % of the suspension;
a total amount of the sodium tetraborate accounts for 1 wt % of the suspension;
a total amount of the magnesium sulfate accounts for 15.5 wt % of the suspension;
the total amount of the carboxymethyl cellulose accounts for 1 wt % of the suspension; and
a total amount of the water accounts for 51.6 wt % of the suspension.

11. The method of any one of clauses 6-10, wherein:
a coating speed of the slot-die coating is 30 cm/min;
a pumping rate of the slot-die coating is 10000 μL/min;
a pre-start pump time is 3 seconds;
a pre-end stop time is 1 second; and/or
a film formed on the anode by the slot-die coating is 350 μm thick.

12. The method of any one of clauses 6-11, wherein the coated cellulose membrane is wet with a 1 mol/L NaOH solution.

13. An aluminum-based secondary battery system, comprising:
a cell stack, comprising:
   an anode comprising aluminum foil;
   a cathode comprising a current collector having a sulfur-based cathode active material coated thereon;
   a solid-state electrolyte layer interposed between the anode and the cathode, the solid-state electrolyte layer comprising a cellulose membrane saturated with a solid-state electrolyte comprising a mixture of urea, sodium chloride, sodium borate, magnesium sulfate, and sodium silicate; and
   in situ solid-electrolyte interphase layers interposed between the cathode and the solid-state electrolyte layer and between the anode and the solid-state electrolyte layer; and
   a pouch enclosing the cell stack,
   wherein the aluminum-based secondary battery system is configured to apply a current pulse to the cell stack.

14. The aluminum-based secondary battery system of clause 13, wherein the sulfur-based cathode active material comprises graphite, sulfur, polyvinyl acetate, and urethane.

15. The aluminum-based secondary battery system of clause 14, wherein the graphite is obtained from a sugar and ammonium chloride reaction.

16. The aluminum-based secondary battery system of any one of clauses 13-15, wherein:
a total amount of the urea and the sodium chloride accounts for 50 wt % to 95 wt % of the mixture;
a total amount of the sodium borate accounts for 0.1 wt % to 25 wt % of the mixture;
a total amount of the magnesium sulfate accounts for 0.1 wt % to 25 wt % of the mixture;
a total amount of the sodium silicate accounts for 0.1 wt % to 10 wt % of the mixture; and
an atomic ratio of sodium chloride to urea is equal to or greater than 1.

17. The aluminum-based secondary battery system of any one of clauses 13-16, wherein the solid-state electrolyte further comprises carboxymethyl cellulose in a total amount of 0.5 wt % to 2 wt % of the solid-state electrolyte.

18. The aluminum-based secondary battery system of any one of clauses 13-17, wherein:
the cellulose membrane comprises a porous structure having a porosity between 10% to 90% by volume; and/or
the cellulose membrane has a thickness between 1 micron and 500 microns.

19. The aluminum-based secondary battery system of any one of clauses 13-18, wherein the aluminum foil is coated with a solid-state electrolyte slurry-based layer having a same composition as the solid-state electrolyte.

20. The aluminum-based secondary battery system of any one of clauses 13-19, wherein the aluminum-based secondary battery system is configured to apply the current pulse at 50 mA.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

1. A solid-state electrolyte composition, comprising:
a mixture comprising urea, sodium chloride, sodium tetraborate, magnesium sulfate, and sodium silicate, wherein:
a total amount of the urea and the sodium chloride accounts for 50 wt % to 95 wt % of the mixture;
a total amount of the sodium tetraborate accounts for 0.1 wt % to 25 wt % of the mixture;
a total amount of the magnesium sulfate accounts for 0.1 wt % to 25 wt % of the mixture;
a total amount of the sodium silicate accounts for 0.1 wt % to 10 wt % of the mixture; and
an atomic ratio of sodium chloride to urea is equal to or greater than 1.

2. The solid-state electrolyte composition of claim 1, wherein the solid-state electrolyte composition is an aqueous slurry.

3. The solid-state electrolyte composition of claim 2, wherein a total amount of the sodium silicate accounts for less than 1 wt % of the aqueous slurry.

4. The solid-state electrolyte composition of claim 2, further comprising carboxymethyl cellulose, wherein a total amount of the carboxymethyl cellulose accounts for 0.5 wt % to 2 wt % of the aqueous slurry.

5. The solid-state electrolyte composition of claim 4, wherein:
a total amount of the urea accounts for 15.5 wt % of the aqueous slurry;
a total amount of the sodium chloride accounts for 15.5 wt % of the aqueous slurry;
a total amount of the sodium tetraborate accounts for 1 wt % of the aqueous slurry;
a total amount of the magnesium sulfate accounts for 15.5 wt % of the aqueous slurry;
the total amount of the carboxymethyl cellulose accounts for 1 wt % of the aqueous slurry; and
a total amount of water accounts for 51.6 wt % of the aqueous slurry.

6. A method for forming an aluminum-based secondary battery, the method comprising:
forming a cathode by:
applying a sulfur-based mixture to coat a current collector;
pressing the coated current collector; and
drying the pressed and coated current collector to form a sulfur-based cathode active material layer thereon;
forming an anode by mechanically and chemically treating an aluminum foil;
forming a suspension by combining urea, sodium chloride, sodium tetraborate, magnesium sulfate, and sodium silicate;
forming a coated anode by:
slot-die coating a first portion of the suspension onto the anode; and
drying the slot-die coated anode;
forming a solid-state electrolyte by:
applying a second portion of the suspension to coat a cellulose membrane; and
drying the coated cellulose membrane;
combining and pressing the cathode, the coated anode, and the solid-state electrolyte;
drying the pressed and combined cathode, coated anode, and solid-state electrolyte to form a cell stack; and
sealing the cell stack in a pouch.

7. The method of claim 6, wherein the urea, the sodium chloride, the sodium tetraborate, the magnesium sulfate, and the sodium silicate are combined as a mixture prior to forming the suspension, wherein:
a total amount of the urea and the sodium chloride accounts for 50 wt % to 95 wt % of the mixture;
a total amount of the sodium borate accounts for 0.1 wt % to 25 wt % of the mixture;
a total amount of the magnesium sulfate accounts for 0.1 wt % to 25 wt % of the mixture;
a total amount of the sodium silicate accounts for 0.1 wt % to 10 wt % of the mixture; and
an atomic ratio of sodium chloride to urea is equal to or greater than 1.

8. The method of claim 6, wherein forming the suspension comprises:
mixing the sodium tetraborate and water to form a first mixture;
adding the magnesium sulfate, the sodium chloride, and the urea to the first mixture and mixing to form a second mixture; and
adding carboxymethyl cellulose to the second mixture.

9. The method of claim 8, wherein a total amount of the carboxymethyl cellulose accounts for 0.5 wt % to 2 wt % of the suspension.

10. The method of claim 9, wherein:
a total amount of the urea accounts for 15.5 wt % of the suspension;
a total amount of the sodium chloride accounts for 15.5 wt % of the suspension;
a total amount of the sodium tetraborate accounts for 1 wt % of the suspension;
a total amount of the magnesium sulfate accounts for 15.5 wt % of the suspension;
the total amount of the carboxymethyl cellulose accounts for 1 wt % of the suspension; and
a total amount of the water accounts for 51.6 wt % of the suspension.

11. The method of claim 6, wherein:
a coating speed of the slot-die coating is 30 cm/min;
a pumping rate of the slot-die coating is 10000 μL/min;
a pre-start pump time is 3 seconds;
a pre-end stop time is 1 second; and/or
a film formed on the anode by the slot-die coating is 350 μm thick.

12. The method of claim 6, wherein the coated cellulose membrane is wet with a 1 mol/L NaOH solution.

13. An aluminum-based secondary battery system, comprising:
a cell stack, comprising:
an anode comprising aluminum foil;
a cathode comprising a current collector having a sulfur-based cathode active material coated thereon;
a solid-state electrolyte layer interposed between the anode and the cathode, the solid-state electrolyte layer comprising a cellulose membrane saturated with a solid-state electrolyte comprising a mixture of urea, sodium chloride, sodium borate, magnesium sulfate, and sodium silicate; and
in situ solid-electrolyte interphase layers interposed between the cathode and the solid-state electrolyte layer and between the anode and the solid-state electrolyte layer; and
a pouch enclosing the cell stack,
wherein the aluminum-based secondary battery system is configured to apply a current pulse to the cell stack.

14. The aluminum-based secondary battery system of claim 13, wherein the sulfur-based cathode active material comprises graphite, sulfur, polyvinyl acetate, and urethane.

15. The aluminum-based secondary battery system of claim 14, wherein the graphite is obtained from a sugar and ammonium chloride reaction.

16. The aluminum-based secondary battery system of claim 13, wherein:
a total amount of the urea and the sodium chloride accounts for 50 wt % to 95 wt % of the mixture;
a total amount of the sodium borate accounts for 0.1 wt % to 25 wt % of the mixture;
a total amount of the magnesium sulfate accounts for 0.1 wt % to 25 wt % of the mixture;
a total amount of the sodium silicate accounts for 0.1 wt % to 10 wt % of the mixture; and
an atomic ratio of sodium chloride to urea is equal to or greater than 1.

17. The aluminum-based secondary battery system of claim 13, wherein the solid-state electrolyte further comprises carboxymethyl cellulose in a total amount of 0.5 wt % to 2 wt % of the solid-state electrolyte.

18. The aluminum-based secondary battery system of claim 13, wherein:
the cellulose membrane comprises a porous structure having a porosity between 10% to 90% by volume; and/or
the cellulose membrane has a thickness between 1 micron and 500 microns.

19. The aluminum-based secondary battery system of claim 13, wherein the aluminum foil is coated with a solid-state electrolyte slurry-based layer having a same composition as the solid-state electrolyte.

20. The aluminum-based secondary battery system of claim 13, wherein the aluminum-based secondary battery system is configured to apply the current pulse at 50 mA.
